(19) United States
(12) Patent Application Publication
(10) Pub. No.: US 2001/0055987 A1
(43) Pub. Date: Dec. 27, 2001

(54) Mobile communication device having image pick-up function

(75) Inventor: Keiichi Tsuchida, Tokyo (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Olympus Optical Cc., Ltd., Tokyo (JP)

(21) Appl. No.: 09/859,272

(22) Filed: May 17, 2001

(30) Foreign Application Priority Data
May 30, 2000 (JP) 2000-161033

(51) Int. Cl. H04B 1/38

(52) U.S. Cl. 455/575; 455/566

(57) ABSTRACT

The mobile communication device of this invention comprises a telephone main body; a display means which is positioned on a surface of the telephone main body, and is capable of displaying the operation content of the mobile communication device and a pick-up image of an object; an image pick-up optical system unit which is positioned on a face other than the face on which is positioned the display means of the telephone main body to pick up the image of the object; and a light emission means to illuminate the object which is positioned on a face on which is positioned the image pick-up optical system unit.

This application claims the benefit of Japanese Application No. 2000-161033 filed in Japan on May 30, 2000, the contents of which are incorporated by this reference.

### BACKGROUND OF THE INVENTION

1. Field of the Invention

This invention relates to a mobile communication device, and in particular a mobile communication device having image pick-up functions.

2. Description of the Related Art

In recent years, there has been rapid growth in the use of mobile communication devices, of which portable telephones are representative. Portable telephones with multiple functions are also in use; for example, in addition to conversation functions (the main functions of a portable telephone), there are also portable telephones in use which have image pick-up functions.

In addition to conversation functions and image pick-up functions, portable telephones which have functions to transmit and receive images which have been picked-up are also known. For example, Japanese Laid-open Patent Publication No. H8-294030 discloses an integrated portable telephone-camcorder. This integrated portable telephone-camcorder is able to transmit images picked up by the camcorder to other equipment via a wireless communication transmission system, that is, via telephone lines.

A portable telephone which also has such functions for picking up images and for transmitting and receiving picked-up images is extremely useful. Compared with a conventional portable telephone having only conversation functions, the presence of functions for picking up images, transmitting and receiving images, and displaying images is extremely convenient for the user, and hereafter an increase in demand for such functions is anticipated.

The following form is conceivable as one example of the external appearance of a portable telephone having such image pick-up functions.

The main external appearance and shape of the telephone main body is nearly the same as that of an ordinary portable telephone not having image pick-up functions. The telephone main body, like ordinary portable telephones, is covered in front by what is called a front cover and in back by what is called a back cover.

Differences in appearance from ordinary portable telephones due to having image pick-up functions include having an optical system unit for image pick-up functions, and an image pick-up operation unit. The optical system unit is normally positioned in front of the telephone main body. The optical system unit comprises, for example, an image pick-up lens and other auxiliary members. It is probable that the image pick-up operation unit will be positioned as switches or buttons, on one side of the telephone main body.

The mode of use of such a portable telephone having image pick-up functions will generally be as follows.

When using a portable telephone with image pick-up functions such as this to pick up images of an object, the user points the front face of the telephone main body, on which the image pick-up lens is positioned, facing the object, and operates the image pick-up button provided on one side of the telephone main body, to pick up an image of the object.

However, when using a portable telephone with image pick-up functions to pick up images of an object, the following problem arises.

As an example in this explanation of a portable telephone having image pick-up functions, the integrated portable telephone-camcorder described in the above Japanese Laid-open Patent Publication No. H8-294030 is explained.

Using this integrated portable telephone-camcorder, when for example picking up images of an object in a dark place, or when picking up images under backlit conditions, it may not be possible to obtain a clear pick-up image. Or, it may not be possible to pick up the object image at all. This is a problem which arises because the object for image pick-up is dark.

In order to pick up a clear image of the object even when the object is dark, the above problem is avoided in the field of photography by providing a strobe unit, that is, by using a strobe unit as a means of illuminating the object with the necessary light during picking up image.

The following are known characteristics of the functions of strobes mounted on cameras.

The illuminating light from a strobe must be of comparatively strong intensity in order to sufficiently illuminate the object (normally positioned at a distance of several tens of centimeters to several meters).

The strobe unit comprises a capacitor to store energy for illumination; when this capacitor is charged, noise occurs.

Noise also occurs in the strobe unit during emitting light.

The above capacitor occupies a large fraction of the volume of the strobe unit.

### SUMMARY OF THE INVENTION

A first object of this invention is to provide a mobile communication device capable of picking up clear images even in dark places.

A second object of this invention is to provide a mobile communication device capable of picking up clear images even in dark places, without imparting to the user an unpleasant sensation.

A third object of this invention is to provide a mobile communication device capable of picking up clear images even in dark places, and which prevents effects accompanying image pick-up.

A fourth object of this invention is to provide a compact mobile communication device capable of picking up clear images even in dark places.

Briefly, the mobile communication device of the present invention comprises a telephone main body; a display means which is positioned on a surface of the telephone main body, and is capable of displaying the operation content of the mobile communication device and a pick-up image of an object; an image pick-up optical system unit which is positioned on a face other than the face on which is positioned the display means of the telephone main body to pick up the image of the object; and a light emission means to illuminate the object which is positioned on a face on which is positioned the image pick-up optical system unit.

The mobile communication device of the present invention comprises a telephone main body; an image pick-up optical system unit to pick up an image of an object; a light emission means to illuminate the object; a switch to select a camera mode to pick up the image of the object by using the image pick-up optical system unit and the light emission means to illuminate the object; and a control means to control each of the operations of the mobile communication device; and in which when the camera mode is selected, control by the control circuit causes the receiving wait state of the mobile communication device to be disconnected and a conversation function to be inhibited.

The mobile communication device of the present invention comprises a display means having functions for displaying the operation content of the mobile communication device and for displaying a picked-up image of an object; an image pick-up optical system unit having a function for image pick-up of the object; and a light emission means to emit light for illumination toward the object; and in which the image pick-up optical system unit and the light emission means are both positioned on a face of the outer packaging of the mobile communication device other than the face on which is positioned the display means.

The mobile communication device of the present invention comprises a telephone main body; an image pick-up optical system unit having a function for image pick-up of an object; a light emission means to emit light for illumination toward the object; and a control means to control each of the general operations of the mobile communication device; and in which when a mode enabling image pick-up by the image pick-up optical system unit is set, control by the control means causes the receiving wait state of the mobile communication device to be canceled and a conversation function to be inhibited.

The above and many other objects, features, and advantages of this invention will become apparent from the ensuing detailed description of one preferred embodiment, which should be read in conjunction with the accompanying drawings.

### BRIEF DESCRIPTION OF THE DRAWINGS

FIG. 1 is a perspective view, seen obliquely from the rear-right side, of a mobile communication device, showing a first embodiment of a mobile communication device of this invention;

FIG. 2 is a perspective view, seen from the front-right side, of the mobile communication device of the first embodiment;

FIG. 3 is a perspective view showing disassembled constituent parts of the mobile communication device of the first embodiment;

FIG. 4 is a perspective view showing a partial cross-section of the mobile communication device of the first embodiment;

FIG. 5 is a flow chart showing one example of image pick-up operation in the mobile communication device of the first embodiment; and, FIG. 6 is a perspective view, seen from the rear-right side, of a mobile communication device, showing a second embodiment of a mobile communication device of this invention.

### DESCRIPTION OF THE PREFERRED EMBODIMENTS

Below, embodiments of this invention are explained, referring to the drawings.

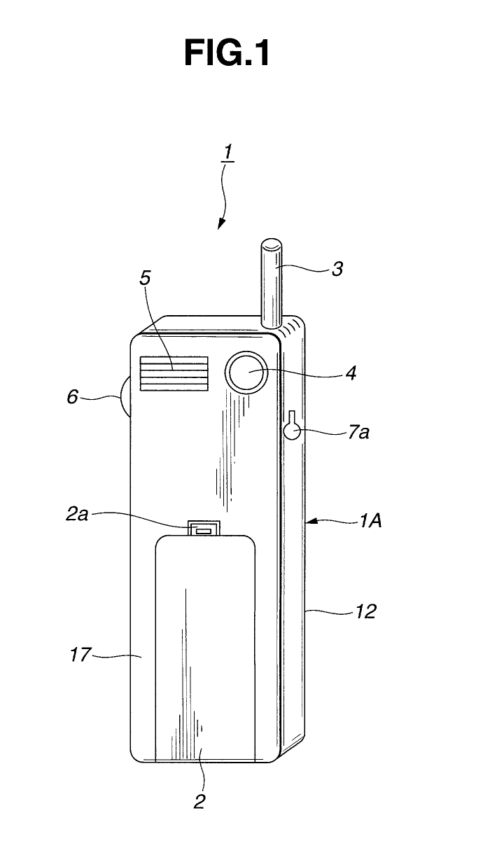

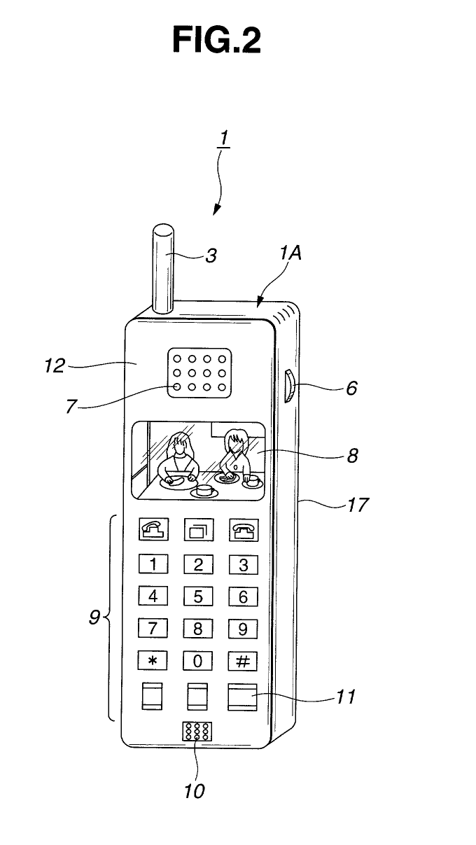

FIG. 1 and FIG. 2 are perspective views, seen from the rear-right side and from the front-right side respectively, of a portable telephone, showing a portable telephone which is the first embodiment of the mobile communication device of this invention.

The portable telephone 1 of the first embodiment shown in FIG. 1, is characterized in having, in addition to ordinary conversation functions, image pick-up functions. The telephone main body 1A is covered on the front side by a front cover 12 and on the back side by a back cover 17, on the back side of the telephone main body 1A is positioned a freely attachable/detachable battery pack 2 to the back cover 17.

This battery pack 2 becomes part of the outer packaging of the telephone main body 1A by attachment to the depression formed in the back cover 17. When attached to the back cover 17, the battery pack 2 is held against the back cover 17 by a lock member 2a. By this means, the battery pack 2 is fixed on the telephone main body 1A.

In this embodiment, a rechargeable-type secondary battery pack is assumed as the battery pack 2. This rechargeable-type secondary battery pack can be charged from an outside source, and supplies the electric power necessary to operate all telephone functions to the main circuit group within the telephone main body 1A.

An antenna 3 is positioned on the top face of the telephone main body 1A. This antenna 3 is for transmitting and receiving communication radio waves.

In the portable telephone 1 of this embodiment, the optical system unit comprises an image pick-up lens 4, and the light emission means comprises a strobe unit 5. By means of this strobe unit 5, the portable telephone of this embodiment can obtain clear pick-up images even in dark places.

The above image pick-up lens 4 and strobe unit 5 are provided at mutually close locations on the rear face of the telephone main body 1A as shown in FIG. 1. That is, the image pick-up lens 4 and strobe unit 5 are provided on the same face of the outer packaging of the telephone main body 1A (in the case of this embodiment, the rear face).

The image pick-up lens 4 is a lens used to pick up an image of an object or objects; light from the object gathered by the image pick-up lens 4 is condensed on a CCD (not shown). This CCD converts the light from the object into electrical signals, which are supplied to a predetermined processing circuit within the telephone main body 1A.

The strobe unit 5 is an auxiliary light source used when picking up images in dark places. In this embodiment, in cases where the mode enabling image pick-up (hereinafter called the “camera mode”) is set, when a sensor (not shown) judges that the object brightness is low, light is emitted automatically by the strobe unit 5 simultaneously with image pick-up to illuminate the object.

By this means the portable telephone of this embodiment can obtain clear pick-up images even in dark places or when the object brightness is low.

As shown in FIG. 1 and FIG. 2, an image pick-up switch 6 is positioned on one side of the telephone main body 1A. On the other side of the telephone main body 1A is positioned an earphone-microphone terminal 7a for insertion of an earphone-microphone.

The image pick-up switch 6 is a switch for executing image pick-up when camera mode is set; when this button is turned on, an image of the object reflected in the image pick-up lens 4 is picked up.

The earphone-microphone input terminal 7a is a terminal for attaching an earphone-microphone (not shown). By attaching an earphone-microphone to this earphone-microphone input terminal 7a, the portable telephone of this embodiment enables conversation during placed on a desk, without holding the telephone main body 1A.

On the front face of the portable telephone 1 is positioned a speaker 7, near the top of the telephone main body 1A as shown in FIG. 2. This speaker is for listening to the voice of the other party in a conversation.

On the front face of the telephone main body 1A are also positioned a display 8, group of buttons 9, microphone 10, and camera mode execute button 11.

The display 8 comprises for example a liquid crystal display, and displays telephone numbers, indicates the presence or absence of energy remaining in the battery, indicates the state receiving radio waves, and displays the object during picking up camera image and other information.

The group of buttons 9 are to perform operations necessary for execution of various functions of the portable telephone. For example, the group of buttons 9 may comprise a plurality of push-switches which are operated when making a telephone call or when entering a telephone number. Specifically, the group of buttons 9 comprises a switch which is turned on before making a telephone call; a switch which is turned on when disconnecting a line; and numeric switches which are turned on when entering a telephone number.

The microphone 10 is a microphonerophone which converts the voice of the portable telephone user into electrical signals. The electrical signals converted by this microphone 10 are transmitted to a wireless transmission system via a voice signal processing circuit (not shown) within the telephone.

The portable telephone of this embodiment has a camera mode execute button 11 as an operation switch to enable execution of image pick-up functions. This camera mode execute button 11 comprises the same push-switch as the above group of buttons 9. When the camera mode execute button 11 is turned on, the portable telephone of this embodiment is set in image pick-up enabled mode, that is, in camera mode.

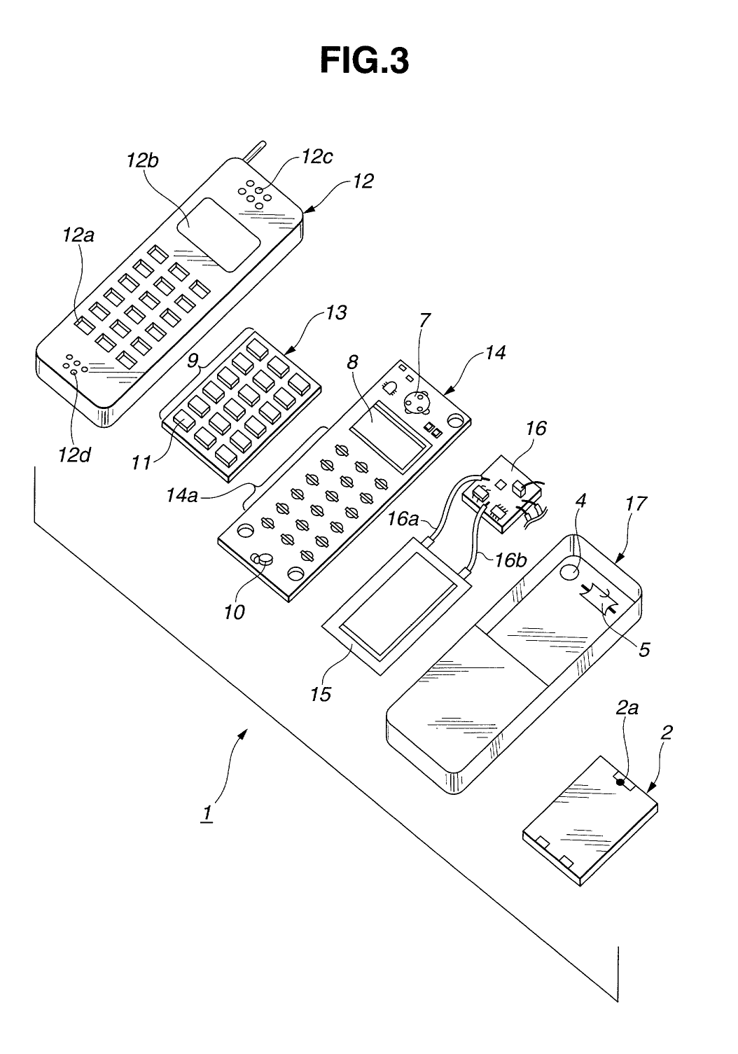

Next, the internal construction of the portable telephone 1 of this embodiment is explained referring to FIG. 3.

FIG. 3 is a perspective view showing from the front side to the back side, disassembled constituent parts of the mobile communication device of the first embodiment.

As shown in FIG. 3, the portable telephone 1 of this embodiment comprises a front cover 12 covering the front side of the portable telephone 1 and a rear cover 17 covering the back side as described above. Part of the battery pack 2 becomes part of the outer packing on the back face of the portable telephone 1. Within the portable telephone 1 covered by this front cover 12 and rear cover 17 are positioned a button unit 13, main circuit board 14, capacitor 15, and strobe circuit board 16.

The above-described front cover 12 is a cover on the front side of the portable telephone 1, in which are formed a plurality of holes 12a through which the above group of buttons 9 pass, a cover 12b for the display 8, a plurality of holes 12c for the speaker 7, and a plurality of holes 12d for the microphone 10.

On the rear side of the above front cover 12 is positioned a button unit 13.

In this button unit 13, the above-described group of buttons 9 and camera mode execute button 11 are integrally formed on a base. Of these buttons, when any one button is pressed, a push switch 14a provided on the main circuit board 14 positioned behind the button unit 13 is turned on.

Behind the above button unit 13 is positioned the main circuit board 14.

On this main circuit board 14 are arranged, in addition to a controller to control the electric components and similar of the entire portable telephone, various electric circuits. Also mounted on the main circuit board 14 are the above described push switch 14a, speaker 7, microphone 10, and display 8.

Behind the above main circuit board 14 are positioned a capacitor 15 to store energy for strobe light emission, and a strobe circuit board 16 on which is mounted a strobe light emission circuit.

This capacitor 15 and the strobe light emission circuit mounted on the strobe circuit board 16 are connected via lead wires 16a, 16b. The strobe 5 positioned on the back cover 17 is also connected to the above strobe light emission circuit.

In this embodiment, a flat-type capacitor is used as the capacitor 15.

The above capacitor 15 is controlled by the strobe light emission circuit and stores energy for strobe light emission. The battery pack 2 serves as the power source for energy for strobe light emission. The above capacitor 15 supplies energy for charged strobe light emission to the above strobe 5 via the strobe circuit board 16.

The back cover 17 is a cover on the back side of the portable telephone 1, on which, as explained above are positioned the image pick-up lens 4 and strobe 5. On the back cover 17 is also installed a battery pack 2, freely attachable/detachable as described above.

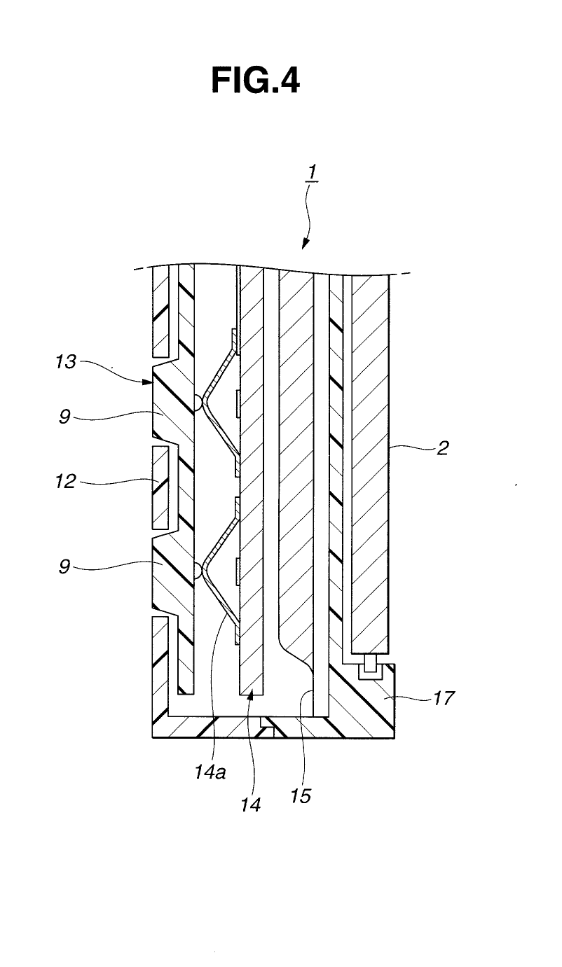

FIG. 4 is a cross-sectional view showing a vertical cross-section of the bottom half of the portable telephone 1 of this embodiment.

Within the portable telephone 1 covered by the front cover 12 and back cover 17, when the above button unit 13, main circuit board 14, capacitor 15 and strobe circuit board 16 and similar are assembled, the result is as shown in the cross-sectional view of FIG. 4. In order to facilitate understanding of the features of the portable telephone, FIG. 4 shows approximately the bottom half of the portable telephone 1, in which are mounted the capacitor 15 and other components.

As shown in FIG. 4, in the portable telephone 1 of this embodiment, the button unit 13, main circuit board 14, capacitor 15, and battery pack 2 are mounted in a parallel arrangement. That is, a feature of the portable telephone 1 of this embodiment is the use of a flat-type capacitor as the capacitor 15 and a layout which combines the flat-type capacitor 15 and other components. As a result, there is no wasted space within the telephone main body of the portable telephone 1, and mounting efficiency can be improved, while also contributing greatly to reduce the size of the portable telephone 1.

Next, the function of the portable telephone 1 of this embodiment is explained.

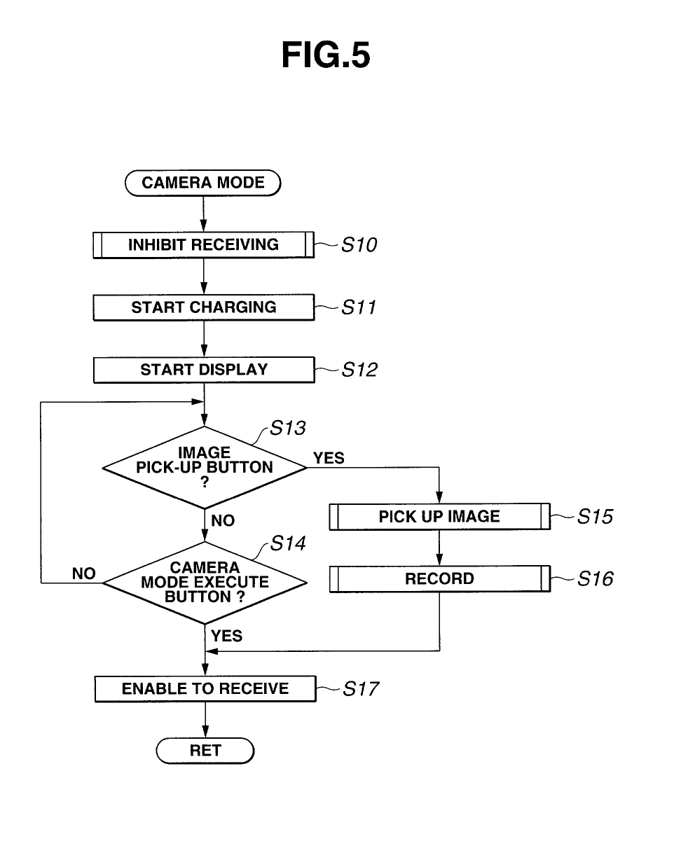

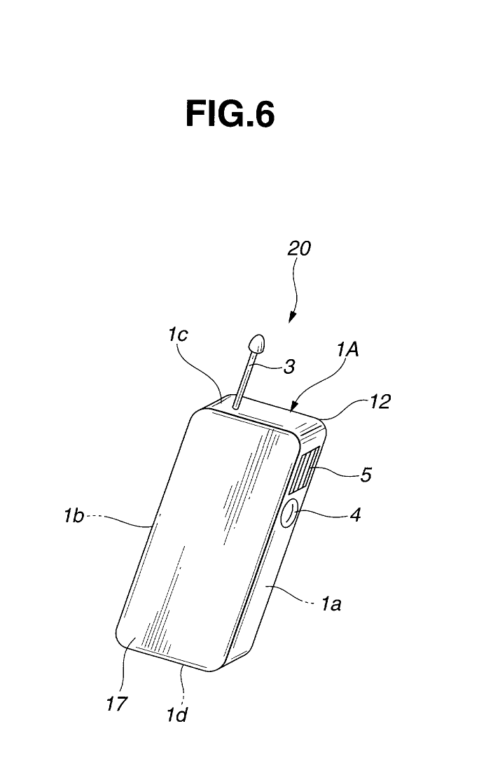

The basic operation of the portable telephone 1 of this embodiment is approximately the same as that of portable telephones sold commercially, and so an explanation is here omitted; only the operation during picking up image is explained referring to the flow chart shown in FIG. 5.

With the power supply of the portable telephone turned on, when the above camera mode execute button 11 (see FIG. 2) is turned on by the user, the control circuit or CPU mounted on the above main circuit board 14 recognizes the turn-on signal from the camera mode execute button 11, and begins the camera mode sequence routine shown in FIG. 5.

When the camera mode routine is begun, the CPU inhibits receiving by the portable telephone 1 (step S10). Processing is performed to delete the radio wave receiving state display shown on the display 8 at that time. Through this processing, that is, by inhibiting receiving by the portable telephone when camera mode is selected, malfunction of the portable telephone 1 due to noise occurring during charging strobe or during emitting light can be prevented.

Thereafter, the CPU performs processing to charge the capacitor 5 (step S11). That is, control is performed such that the strobe 5 can emit light. Next, the CPU controls such that the image picked up by the image pick-up lens 4 is displayed on the display 8 (step S12).

The CPU then judges the state of the image pick-up button 6 (step S13). If it is judged that the button is not turned on, execution is transferred to step S14; if it is judged to be turned on, execution is transferred to step S15.

In the above step S13, if the CPU judges that the image pick-up button 6 is not turned on, judgment is then performed to determine whether the camera mode execute button 11 is turned on (step S14). In this step S14, if it is judged that the camera mode execute button 11 is not turned on, the CPU processing returns to step S13. If the camera mode execute button 11 is judged to be turned on, it is judged that during executing, the camera mode was canceled by the user, and the receiving operation which had been stopped is enabled to receive (step S17); simultaneously, the camera mode processing routine is ended, and execution returns to the main routine (for example, a main routine which includes conversation processing and display processing).

In the above step S13, when turn-on of the image pick-up button 6 is detected, the CPU begins the image pick-up routine (step S15). In this image pick-up routine, under CPU control the object image taken by the image pick-up lens 4 is converted into object signals by the CCD, and the object signals are supplied to a predetermined processing circuit.

In this image pick-up routine, the CPU judges the state of an object brightness detection sensor (not shown). If, as a result of detection by this sensor, the object brightness is judged to be low, the strobe 5 is caused to emit light.

After this above image pick-up routine, the CPU records the picked-up image in memory or other recording means (not shown) as pick-up image data (step S16), and controls to display this image on the display 8. The above memory is provided on the above main circuit board 14.

After recording pick-up image data in step S16, the CPU enables receiving operation which had been inhibited (step S17), and simultaneously ends the camera mode execute routine and returns control to the main routine (for example, a main routine including conversation processing and display processing).

As explained above, in the portable telephone of the first embodiment, an image pick-up lens 4 and strobe unit 5 are positioned on the back side of the portable telephone, so that even if the strobe is inadvertently made to emit light during operating key or during making conversation, which is ordinarily the main function of a portable telephone, the user is not blinded or otherwise discomforted.

In the portable telephone of the first embodiment, the above button unit 13, main circuit board 14, flat-type capacitor 15, and battery pack 2 are arranged in parallel, and thereby there is no wasted space within the telephone main body, so that mounting efficiency can be improved, while also contributing greatly to reduce the size of the portable telephone itself.

The portable telephone of the first embodiment inhibits receiving by a telephone when the image pick-up enabled mode (camera mode) is selected, so that even in cases where noise components may occur, as in charging of the strobe unit or emission of light, no adverse effects are imparted on operation as a telephone, and so telephone performance can be made more stable.

Next, the portable telephone of a second embodiment of the invention is explained.

FIG. 6 is a perspective view seen from the oblique rear-right side of a mobile communication device showing a portable telephone which is a second embodiment of a mobile communication device of this invention.

This portable telephone of the second embodiment is characterized in that, in comparison with the portable telephone of the first embodiment in which the image pick-up lens and strobe unit are positioned on the back side of the telephone main body, the image pick-up lens and strobe unit are provided on one side of the telephone main body.

That is, in the portable telephone 20 of the second embodiment shown in FIG. 6, the main functions as a telephone are the same as in the portable telephone of the first embodiment; but as shown in FIG. 6, the image pick-up lens 4 and strobe unit 5 are provided on one side 1a of the telephone main body 1A. The configuration of the portable telephone of the second aspect is otherwise the same as in the above first embodiment, and the image pick-up routine in camera mode is also the same as in the first embodiment, so that a detailed explanation is here omitted.

When using the portable telephone of the second embodiment to execute the above camera mode and pick up images, the user points the side 1a of the telephone main body on which are positioned the image pick-up lens 4 and strobe unit 5 in the direction of the object, and performs image pick-up.

The portable telephone of the second embodiment is configured with the image pick-up lens 4 and strobe unit 5 provided on one side 1a; other examples are conceivable in which the image pick-up lens 4 and strobe unit 5 are positioned on an arbitrary face other than the face on which the display 8 is positioned. For example, in configurations in which the image pick-up lens 4 and strobe unit 5 are provided on the other side 1b, the top face 1c, or the bottom face 1d of the telephone main body 1A, an advantageous result similar to that of this aspect can be obtained.

According to the portable telephone of the second embodiment, an advantageous result similar to that of the above first embodiment can be obtained.

In the portable telephone of the above first and second embodiments, the positions of the camera mode execute button 11 and image pick-up button 6 are not thereby limited; of course positions other than those of these embodiments are possible, and there is no effect on the advantageous result of this invention.

As explained above, the portable telephone of the above first and second embodiments is configured such that the image pick-up lens 4 and strobe unit 5 are positioned on either side faces, the upper face, or the lower face of the telephone main body 1A, other than the face on which is positioned the display 8. However, this invention is not thereby limited; for example, a separate unit may be provided in which the image pick-up lens 4 and strobe unit 5 are made separate from the telephone main body 1A, and this separate unit may be connected to the telephone main body 1A. That is, this separate unit may be connectable to the telephone main body 1A, and this separate unit may be positioned so as to be freely rotatable in directions other than the forward direction. In this case also, it is clear that an advantageous result similar to that for the above first and second embodiments is obtained.

The above first and second aspects have been explained for the case of a CCD used as the image sensor; but a CMOS image sensor or similar may also be used.

While this invention has been described in detail referring to one preferred embodiment of the invention, it should be understood that the invention is not limited to that precise embodiment. Rather, many modifications and variations will be apparent to those skilled in the art without departing from the scope and spirit of the invention as defined in the appended claims.

What is claimed is:

1. A mobile communication device, comprising
a telephone main body;
a display means which is positioned on a surface of the telephone main body, and is capable of displaying the operation content of the mobile communication device and a pick-up image of an object;
an image pick-up optical system unit which is positioned on a face other than the face on which is positioned the display means of the telephone main body to pick up the image of the object; and
a light emission means to illuminate the object which is positioned on a face on which is positioned the image pick-up optical system unit.

2. The mobile communication device according to claim 1, wherein the light emission means is a strobe unit, comprising a capacitor to store energy for light emission, and the capacitor is arranged in parallel with a circuit board on which group of electric circuits necessary to operate the entire telephone are mounted.

3. The mobile communication device according to claim 2, wherein the capacitor is arranged in parallel with an electric power supply which supplies electric power necessary to operate the mobile communication device to the circuit board.

4. The mobile communication device according to claim 2, wherein the capacitor is a flat-type capacitor.

5. A mobile communication device, comprising
a telephone main body;
an image pick-up optical system unit to pick up an image of an object;
a light emission means to illuminate the object;
a switch to select a camera mode to pick up the image of the object by using the image pick-up optical system unit and the light emission means to illuminate the object; and
a control means to control each of the operations of the mobile communication device; and wherein
when the camera mode is selected, control by the control circuit causes the receiving wait state of the mobile communication device to be disconnected and a conversation function to be inhibited.

6. The mobile communication device according to claim 5, wherein the light emission means to illuminate the object is a strobe unit, comprising a capacitor to store energy for light emission.

7. A mobile communication device according claim 5, further comprising a display means which is positioned on a surface of the telephone main body, and is capable of displaying the operation content of the mobile communication device and the pick-up image of the object;
and wherein the image pick-up optical system unit and the light emission means to illuminate the object are positioned on a face other than the face on which is positioned the display means of the telephone main body.

8. A mobile communication device, comprising
a display means having functions for displaying the operation content of the mobile communication device and for displaying a picked-up image of an object;
an image pick-up optical system unit having a function for image pick-up of the object; and
a light emission means to emit light for illumination toward the object; and wherein
the image pick-up optical system unit and the light emission means are both positioned on a face of the outer packaging of the mobile communication device other than the face on which is positioned the display means.

9. The mobile communication device according to claim 8, wherein the light emission means is a strobe unit, comprising a capacitor to store energy for light emission, and the capacitor is arranged in parallel with both the main circuit board having the principal electric circuits within the mobile communication device and the electric power supply which supplies electric power to charge the capacitor.

10. The mobile communication device according to claim 9, wherein the capacitor is a flat-type capacitor.

11. A mobile communication device, comprising
a telephone main body;
an image pick-up optical system unit having a function for image pick-up of an object;
a light emission means to emit light for illumination toward the object; and
a control means to control each of the general operations of the mobile communication device; and wherein
when a mode enabling image pick-up by the image pick-up optical system unit is set, control by the control means causes the receiving wait state of the mobile communication device to be canceled and a conversation function to be inhibited.
